(19) United States
(12) Patent Application Publication
(10) Pub. No.: US 2026/0309853 A1
(43) Pub. Date: Oct. 8, 2026

(54) METHOD AND SYSTEM FOR IDENTIFYING RADIATED NOISE OF SHIPS, DEVICE, AND MEDIUM

(71) Applicant: Northwestern Polytechnical University, Xi'an (CN)

(72) Inventors: Zipeng LI, Xi'an (CN); Feng LIU, Xi'an (CN); Kunde YANG, Xi'an (CN); Rui DUAN, Xi'an (CN); Bingyong GUO, Xi'an (CN)

(21) Appl. No.: 19/366,790

(22) Filed: Oct. 23, 2025

(30) Foreign Application Priority Data
Apr. 7, 2025 (CN) 2025104212445

(51) Int. Cl. G01S 7/52; G01S 15/04

(52) U.S. Cl. CPC G01S 7/52001; G01S 15/04

(57) ABSTRACT

A method and system for identifying radiated noise of a ships, a device and a medium are provided. The method includes: acquiring radiated noise signals generated by ships; constructing a wave equation based on a physical law followed by the radiated noise signals during propagation of the radiated noise signals; constructing a first loss function based on differences between actual types of the ships indicated by the radiated noise signals and predicted types of the ships output by PINNs; constructing a second loss function by taking whether the predicted types output by the PINNs satisfy the wave equation as a constraint for outputs of the PINNs; training the PINNs by using the radiated noise signals to thereby obtain trained PINNs; optimizing network parameters of the PINNs through the first loss function and the second loss function; and identifying the radiated noise of the ships through the trained PINNs.

### CROSS-REFERENCE TO RELATED APPLICATION

This application claims priority to Chinese Patent Application No. 202510421244.5, filed on Apr. 7, 2025, which is herein incorporated by reference in its entirety.

### TECHNICAL FIELD

The disclosure relates to the field of underwater acoustic detection technologies, and more particularly to a method and system for identifying radiated noise of ships, a device, and a medium.

### BACKGROUND

Collecting passive radiated noise from ships by using hydrophones and performing feature extraction for ship classification and identification is of great significance in promoting development of marine economy and protecting national maritime rights and interests. Identification methods in the past rely on expert experience, mainly by skilled technicians to process noise signals, extract features, and identify and confirm ship types. Due to complex and ever-changing marine environment and various types of ocean noise (such as marine animals, artificial operation noise, wave noise, etc.), manual identification faces significant challenges.

With a rise of artificial intelligence technology, research on methods using neural networks to automatically and accurately identify the ship types has become a development trend. Currently, when using deep learning to identify the passive radiated noise of ships (i.e., the ship classification and identification), a model building process only relies on passive radiated noise data of ships, namely, pure data, without considering a physical law followed by the passive radiated noise data during propagation of the passive radiated noise data, resulting in poor identification performance.

### SUMMARY

The disclosure aims to provide a method and system for identifying radiated noise of ships, a device, and a medium, to thereby improve performance on identifying the radiated noise of the ships.

To solve the aforementioned technical problems, the method for identifying the radiated noise of the ships provided by an embodiment of the disclosure includes the following steps:
acquiring radiated noise signals generated by ships during navigation of the ships;
constructing, based on a physical law followed by the radiated noise signals during propagation of the radiated noise signals, a wave equation;
constructing, based on differences between actual types of the ships indicated by the radiated noise signals and predicted types of the ships output by physics-informed neural networks (PINNs) based on the radiated noise signals, a first loss function; and constructing, by taking whether the predicted types of the ships output by the PINNs satisfy the wave equation as a constraint for outputs of the PINNs, a second loss function;
training the PINNs by using the radiated noise signals to thereby obtain trained PINNs, and optimizing, based on the first loss function and the second loss function, network parameters of the PINNs during training the PINNs; and
identifying the radiated noise of the ships by using the trained PINNs.

In an embodiment, after the identifying the radiated noise of the ships by using the trained PINNs, types of the ships are obtained. The types of the ships can be fused with trajectory information of an automatic identification system (AIS) to construct maritime target distribution maps or enable tracking of specific targets, and can also be applied in maritime surveillance and traffic control, and underwater confrontation.

In an embodiment, the wave equation is expressed as follows:

$$\frac{{\partial }^{2} u}{\partial {t}^{2}} = {c}^{2} {∇}^{2} u ,$$

where u represents a sound pressure, c represents a sound speed, t represents a time, and ∇²u represents a Laplace operator.

In an embodiment, the taking whether the predicted types of the ships output by the PINNs satisfy the wave equation as a constraint for outputs of the PINNs output is expressed as follows:

$$\frac{{\partial }^{2} u}{\partial {t}^{2}} - {c}^{2} {∇}^{2} \hat{u} \approx 0 ;$$

and the second loss function is expressed as follows:

$${L}_{physics} = \frac{1}{M} {\sum }_{j = 1}^{M} {( \frac{{\partial }^{2} \hat{u} ( {x}_{j} , {t}_{j} )}{\partial {t}^{2}} - {c}^{2} {∇}^{2} \hat{u} ( {x}_{j} , {t}_{j} ) )}^{2} ;$$

where, L_{physics} represents the second loss function, (xⱼ,tⱼ) represents spatial and temporal coordinates of an j-th sampling point, û(xⱼ,tⱼ) represents an approximate solution of a sound pressure field predicted by the PINNs with parameters θ,

$$\frac{{\partial }^{2} \hat{u} ( {x}_{j} , {t}_{j} )}{\partial {t}^{2}}$$

represents a second derivative of the outputs of the PINNs with respect to time, ∇²û(xⱼ,tⱼ) represents a second derivative of the outputs of the PINNs with respect to space, and M represents a number of samples.

In an embodiment, the wave equation is expressed in a strong form or a weak form of the physical law followed by the radiated noise signals during the propagation of the radiated noise signals; and
the first loss function includes a residual of the wave equation when the wave equation is expressed in the strong form of the physical law; or the first loss function is derived from an energy functional of the wave equation when the wave equation is expressed in the weak form of the physical law.

In an embodiment, the optimizing, based on the first loss function and the second loss function, network parameters of the PINNs during training the PINNs includes:
optimizing, based on weights of the first loss function and the second function, the network parameters of the PINNs with a goal of minimizing the first loss function and the second function during training the PINNs; in which the weights of the first loss function and the second loss function are dynamically adjusted during training the PINNs.

In an embodiment, each of the network parameters of the PINNs is optimized through the following formula:

$${θ}_{t + 1} = {θ}_{t} - η \frac{{m}_{t}}{\sqrt{{v}_{t}} + ϵ} ,$$

where θₜ represents the network parameter of the PINNs, θₜ₊₁ represents an optimized network parameter of the PINNs, mₜ represents an exponentially weighted moving average of a gradient, vₜ represents an exponentially weighted moving average of a square gradient, η represents a learning rate, and e represents a preset numerical stability.

In an embodiment, the first loss function is constructed based on a cross-entropy loss function.

The system for identifying the ship radiated noise provided by another embodiment of the disclosure includes:
a signal acquisition module, configured to acquire the radiated noise signals generated by the ships during the navigation of the ships;
an equation construction module, configured to construct the wave equation based on the physical law followed by the radiated noise signals during the propagation of the radiated noise signals;
a function construct module, configured to: construct the first loss function based on the differences between the actual types of the ships indicated by the radiated noise signals and the predicted types of the ships output by the PINNs based on the radiated noise signals, and construct the second loss function by taking whether the predicted types of the ships output by the PINNs satisfy the wave equation as the constraint for the outputs of the PINNs;
a network training module, configured to train the PINNs by using the radiated noise signals to thereby obtain the trained PINNs and optimize the network parameters of the PINNs based on the first loss function and the second loss function during training the PINNs; and
a ship identification module, configured to identify the radiated noise of the ships through the trained PINNs.

A computer device provided by further another embodiment of the disclosure includes at least one processor, and a memory communicatively connected with the at least one processor. The memory is configured to store instructions executable by the at least one processor. The instructions are executed by the at least one processor to make the at least one processor to execute the method for identifying the radiated noise of the target as described above.

A non-transitory computer-readable storage medium stored a computer program thereon is provided by still another embodiment of the disclosure. The method for identifying the radiated noise of the ships as described above is executed when the computer program is executed by a processor.

The method for identifying the radiated noise of the ships provided by the disclosure has at least the following beneficial effects.

By introducing the wave equation constructed based on the physical low followed by the radiated noise signals during the propagation of the radiated noise signals, a total loss function of the PINNs not only include a loss of training data (i.e. the first loss function), but also include a physical loss based on the wave equation constructed through the wave equation (i.e. the second loss function). When training the PINNs by using the radiated noise signals generated by the ships during the navigation of the ships, the physical loss is used to constraint a training process, and actual physical phenomena is taken into account, so that the trained PINNs have better identification performance. Moreover, with addition of the physical loss, the loss of training data is no longer a main factor affecting model training, thereby eliminating a need for large-scale datasets for training and reducing a probability of model overfitting.

### BRIEF DESCRIPTION OF DRAWINGS

One or more embodiments are illustrated by diagrams in corresponding attached drawings, and these illustrative descriptions do not constitute limitations on the embodiments.

FIG. 1 illustrates a flowchart of a method for identifying radiated noise of ships according to an embodiment of the disclosure.

FIG. 2 illustrates a schematic block diagram of the method for identifying the radiated noise of the ships according to the embodiment of the disclosure.

FIG. 3 illustrates a first signal timing diagram according to the embodiment of the disclosure.

FIG. 4 illustrates a second signal timing diagram according to the embodiment of the disclosure.

### DETAILED DESCRIPTION OF EMBODIMENTS

To make objectives, technical solutions, and advantages of the disclosure clearer, embodiments of the disclosure will be described in detail as follows with reference to attached drawings. However, those skilled in the art should understand that, in the embodiments of the disclosure, many technical details are set forth to help readers better understand the disclosure. However, the technical solutions claimed by the disclosure can be realized even without these technical details and various changes and modifications based on the following embodiments. The following embodiments are divided for convenience of description, and should not constitute any limitation on specific implementation methods of the disclosure. The embodiments can be combined with each other and quoted from each other without conflicting with each other.

Signal identification methods in the art are mainly divided into: (1) identification methods based on traditional signal processing methods; (2) identification methods based on modern intelligent information processing and deep learning.

### (1) Identification Methods Based on Traditional Signal Processing Methods

A central idea of the identification methods based on the traditional signal processing methods is “like attracts like”, that is, similar samples are close to each other in a pattern space. Some information differences inevitably exist between samples of different patterns, and these differences are usually reflected through some measurement methods, such as entropy and distance functions. The identification methods based on the traditional signal processing methods generally consist of three steps, namely data preprocessing, feature extraction, and classification.

i. Data Preprocessing

Methods for data preprocessing in the art mainly include two categories of filtering and wavelet analysis. The methods of filtering mainly include Wiener filtering, Kalman filtering and adaptive filtering. The Wiener filtering has advantages of real-time filtering, effective noise reduction, and wide application, but has disadvantages of high demand for statistical features and difficulty in processing nonlinear and non-Gaussian signals. Advantage of the Kalman filtering is that it can deal with uncertainty and randomness, is suitable for real-time estimation, and has good estimation performance for stochastic systems, but it has high computational complexity. The adaptive filtering has advantages of stronger adaptability, better filtering performance and self-adaptive adjustment of filter parameters, but some “music noise” still exists, and background noise has a great influence on performance. The methods of wavelet analysis mainly include soft threshold denoising and hard threshold denoising. Advantages of the soft threshold denoising are simple computation and easy implementation, and ability to keep main characteristics of a signal. Advantages of the hard threshold denoising are that it can retain more characteristics of the signal, especially when a strength of the signal changes greatly. However, a common problem of these two methods is difficulty in choosing an appropriate threshold, and the latter (i.e., the hard threshold denoising) is easy to produce false information.

ii. Feature Extraction

Methods for feature extraction in the art are mainly divided into time domain, time-frequency domain and cepstral domain feature extraction methods. 1. The time domain feature extraction methods mainly include noise envelope modulation detection, and low-frequency analysis and recording spectrum. Advantages of the noise envelope modulation detection are strong non-linear and non-stationary signal processing ability, and higher frequency and time resolution, but overfitting may occur. Advantages of the low-frequency analysis and recording spectrum are powerful real-time data processing ability, as well as high time and frequency resolution, but an application range of the low-frequency analysis and recording spectrum is limited by frequency bands. 2. The time-frequency domain feature extraction methods mainly include empirical mode decomposition (EMD), complete ensemble empirical mode decomposition with adaptive noise (CEEMDAN), variational mode decomposition (VMD) and short-time Fourier transform. Advantages of the EMD are that the EMD does not require preset basis functions, can process nonlinear and non-stationary signals, and can preserve local features of the signal, but it is prone to mode aliasing and endpoint effects. The CEEMDAN has advantages of strong adaptability, which can avoid influence of excessive noise on decomposition results, and is not limited by prior assumptions, but it needs to choose appropriate noise parameters and has a longer training and processing time due to large-scale data. Advantages of the VMD are that it can avoid modal aliasing, has strong frequency resolution, and has a wider application range, but it requires preset decomposition parameters. Advantages of the short-time Fourier transform are that it can analyze frequency components of the signal at different time points, a spectrum diagram can directly display time and frequency distribution of the signal, and a computational process is intuitive and easy to implement, but it is difficult to process signals with fast changes and variable frequencies. 3. The cepstral domain feature extraction methods mainly include cepstral mean subtraction, cepstral mean normalization, and Mel-scale frequency cepstral coefficients (MFCC). Advantages of the cepstral mean subtraction are that it can effectively remove environmental noise and is simple and efficient in computation, but it is ineffective for non-stationary noise. The cepstral mean normalization has advantages of strong stability and suitability for various conditions, but its performance in processing dynamic noise is poor. Advantages of the MFCC are that it can effectively distinguish different speech or audio samples and has excellent feature extraction ability, but it is too sensitive to noise.

iii. Classification

Mainstream classification methods in the art mainly include decision tree, support vector machine and K-nearest neighbor. Advantages of the decision tree are that it has strong interpretability and can effectively deal with nonlinear problems, but it is prone to overfitting and falling into local optima. Advantages of the support vector machine are that it has better generalization ability and can effectively deal with high-dimensional data, but it has a longer training time. Advantages of the K-nearest neighbor are that it is suitable for small-scale datasets and can effectively deal with nonlinear problems, but it is prone to dimensional disasters.

### (2) Identification Methods Based on Modern Intelligent Information Processing and Deep Learning

With improvement of computer technology and big data, deep learning has made breakthroughs in many problems that are previously difficult to solve. With advantages of deep learning, identification models based on modern intelligent information processing and deep learning have also made revolutionary progress, and identification models based on the traditional signal processing methods will gradually be replaced. For example, someone has proposed an identification method based on attention mechanism. Specifically, a residual neural network (RNN) is used to extract spectral features of the signal, followed by introduction of the attention mechanisms to augment the spectral features, and finally classification is performed based on the spectral features. However, when a scale of a dataset is too small, severe overfitting may occur. Based on this, a multi-scale Hough transform (MHT) is proposed, and a new self-supervised identification model is established on this basis. In the new self-supervised identification model, firstly, MHT is used to learn time-frequency information from Mel Spectrogram, and then the MHT is used to learn deep features of a target. The new self-supervised identification model can reduce dependence of a training process on large-scale datasets, but has poor adaptability to environment. The identification of radiated noise signal of ships is transformed into open set identification, and an identification model based on fused graph convolution network and full parameterization is proposed. The identification model based on fused graph convolution network and full parameterization can not only resist interference of background noise, but also classify various radiated noise signals of ships. But these advantages are realized on a basis of the large-scale datasets. On this basis, there is a new modeling approach where one-dimensional target signals are converted into two-dimensional signals and then identified. However, this method is not ideal for identifying cargo ships. A core concept of an identification model based on weighted average Dempster-Shafer (WA-DS) decision fusion is to fuse MFCC, gammatone frequency cepstral coefficients (GFCC), and time-frequency (TF), and then use Resnet18 and a basic probability distribution function to make classification decisions. This method integrates various features to obtain high-precision identification results, but has high requirement on computational resources. To sum up, the identification models based on modern intelligent information processing and deep learning have problems such as lack of the large-scale datasets, lack of connection between models and actual physical phenomena, and high computational complexity.

Although there are some bottlenecks in the identification methods based on modern intelligent information processing and deep learning, significant progress has been made in key technologies for feature extraction, creating a good starting point for further exploration of ship radiated noise identification technology. Therefore, deep learning will be a powerful tool for studying ship radiated noise identification and is worth further research.

Solutions for identifying the radiated noise of the ships based on deep learning have the following types.
i. Solution 1. Due to lack of labeled data acquisition, inherent time-varying characteristics of signals, and interference from other noise sources, underwater acoustic target identification has always been one of the most challenging tasks in underwater signal processing. Although some deep learning methods have been proved to achieve the most advanced accuracy, accuracy of identification tasks can be improved by designing residual network and optimizing feature extraction. To more comprehensively express underwater acoustic signals, this solution firstly introduces a three-dimensional fused feature extraction method along with a SpecAugment-based data augmentation strategy. Subsequently, a Resnet18 architecture including a center loss function and an embedding layer is designed to train aggregated features with an adaptive learning rate. The solution includes five parts, namely, data preprocessing, feature extraction, residual network, and embedding layer. The feature extraction includes feature computation, feature fusion, and feature augmentation.

However, the solution has the following defects. 1. A processing flow of the solution is too long, and the solution spends a lot of time in feature computation, feature fusion and feature augmentation. In addition, a network structure of the Resnet18 architecture is complex, leading to a long time consumption of the solution. 2. The solution adopts a data augmentation strategy to solve a problem of lack of labeled datasets, but a loss function in a training process is only based on a loss of data, and does not embed physical constraints into a total loss, which leads to separation of the training process from the actual physical phenomena.
ii. Solution 2. Category imbalance is an objective problem in underwater acoustic datasets, but it has rarely received attention and often leads to lower identification accuracy for a few categories. A main purpose of this solution is to provide an effective method for identifying imbalanced underwater acoustic datasets. Therefore, an exponential weighted cross-entropy loss is proposed as a loss function of a convolutional neural network (CNN), and an influence factor is added to a standard cross-entropy loss based on a prediction probability of each sample.

However, the solution has the following defects. Although this solution has to some extent solved the problem of categories imbalance in the underwater acoustic datasets, the exponential weighted cross-entropy loss newly proposed as the loss function of the CNN is still trained based on pure data and does not consider a physical law that the underwater acoustic signals follow during propagation of the underwater acoustic signals.
iii. Solution 3. The ship radiated noise identification is an important and complex task in marine information system construction and marine scientific research. Environment noise, unstable frequency shift, and irregular multipath interference make accurate identification of ship radiated noise complicated. Identification methods in the art have limited ability to identify motion states of the ships, leading to unsatisfactory application results. In order to reduce computational complexity and effectively identify the motion states of the ships, this solution proposes a time-frequency Swin-Transformer network, and proposes a hierarchical self-attention module to extract multi-layer time-frequency features, so that the time-frequency Swin-Transformer network can learn features of moving targets in time-frequency representation of radiated noise of the moving targets.

However, the solution has the following defects. Although this solution reduces the computational complexity of an algorithm to some extent and improves the identification accuracy, the physical law followed by the signals during propagation of the signal is not taken into account during a model building process.

Therefore, methods for identifying the radiated noise of the ships in the art have datasets with small-scale, are prone to overfitting during the training process, have high computational complexity, requires a long computation time; and just use the datasets for training without combining the training process with the actual physical phenomena.

On this basis, the disclosure provides a method for identifying the ship radiated noise to solve the aforementioned technical problems.

An embodiment of the disclosure relates to the method for identifying the radiated noise of the ships. Implementation details of the method for identifying the radiated noise of the ships in this embodiment are described in detail below. The following content is provided for the convenience of understanding details provided in the disclosure and is not necessary for implementing the disclosure.

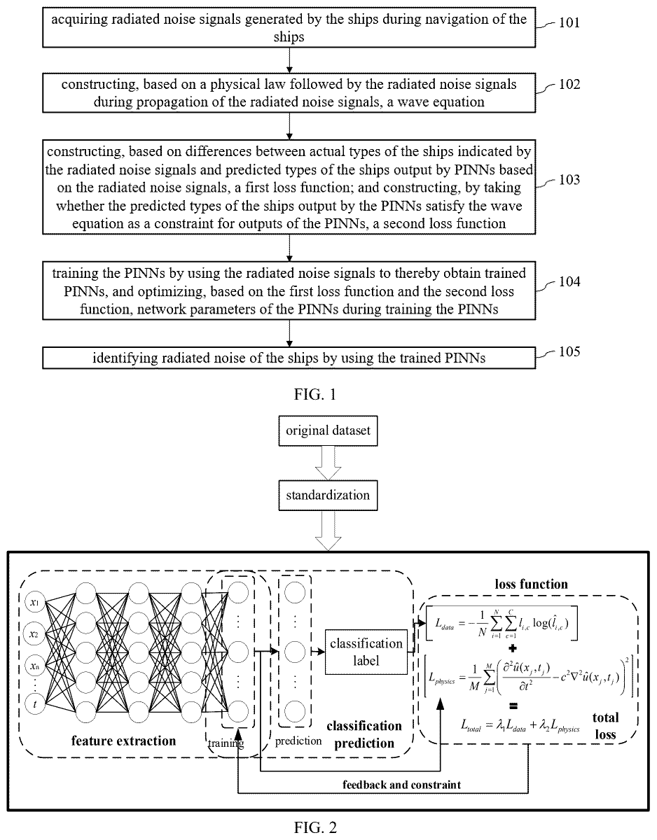

A specific flow of the method for identifying the radiated noise of the ships in the embodiment is illustrated in FIG. 1, including step 101 through step 105.

Step 101, radiated noise signals generated by the ships during navigation of the ships are acquired.

Specifically, the radiated noise signals generated by the ships during the navigation of the ships are firstly acquired to obtain original radiated noise signals. The original radiated noise signals are then normalized to obtain normalized radiated noise signals. The normalized radiated noise signals are subsequently used as inputs for PINNs.

A normalization formula is expressed as follow:

$${S}_{n o r m} ( n ) = \frac{s ( n ) - {S}_{min} ( n )}{{S}_{max} ( n ) - {S}_{min} ( n )} ,$$

where n represents a length of the original radiated noise signal, s(n) represents an original radiated noise signal, Sₘᵢₙ(n) represents a minimum value of the original radiated noise signal, Sₘₐₓ(n) represents a maximum value of the original radiated noise signal, and Sₙₒᵣₘ(n) represents a normalized signal of the original radiated noise signal.

This method can ensure that all values of the original radiated noise signals are in a same range, which helps eliminate scale difference between elements, especially for data with a large amplitude variation.

Step 102, a wave equation is constructed based on a physical law followed by the radiated noise signals during propagation of the radiated noise signals.

Specifically, the physical law followed by the radiated noise signals during propagation is expressed by the wave equation. In context of ship classification task, propagation processes of sound waves can be described by the wave equation. The wave equation is a basic physical law to describe the propagation process of the sound waves in media.

The wave equation constructed at this time is specifically expressed as follows:

$$\frac{{\partial }^{2} u}{\partial {t}^{2}} = {c}^{2} {∇}^{2} u ,$$

where u represents a sound pressure, c represents a sound speed, t represents a time, and ∇²u represents a Laplace operator.

Step 103, a first loss function is constructed based on differences between actual types of the ships indicated by the radiated noise signals and predicted types of the ships output by the PINNs based on the radiated noise signals. A second loss function is constructed by taking whether the predicted types of the ships output by the PINNs satisfy the wave equation as a constraint for outputs of the PINNs.

Specifically, the PINNs are a machine learning model that combines deep learning and physics knowledge. Different from traditional data-driven neural networks, the PINNs use physical laws to guide a model during a learning process, thereby improving generalization ability of the model, especially in situation with limited data or high noise. Therefore, the embodiment uses the PINNs as a network architecture of a model provided by the disclosure. During a training process of a network, a loss function is an important component. The disclosure constructs the first loss function based on the differences between the actual types of the ships indicated by the radiated noise signals and the predicted types of the ships output by the PINNs based on the radiated noise signals and constructs a second loss function by taking whether the predicted types of the ships output by the PINNs satisfy the wave equation as the constraint for the outputs of the PINNs. That is, a total loss function of the model proposed by the disclosure not only includes data error, but also includes a residual based on the physical law. When the PINNs are applied to feature extraction of the radiated noise signals of the ships, a total loss function of the PINNs consists of a data loss and a physical loss.

Specifically, establishment and initial setting of the PINNs are as follows. An objective function u(x,t) on an input domain x∈Ω and a time interval t∈(0,T) is defined. The PINNS u_{NN}(x,t;θ) predict the objective function u(x,t). θ represents trainable parameters of the PINNs (i.e. network parameters). A framework of the PINNs usually adopts a fully connected feedforward neural network composed of an input layer, multiple hidden layers and an output layer. For example, the PINNs predict a required physical value u_{NN}(x,t) through an input (x,t). The outputs of the PINNs are expressed as follows:

$${u}_{NN} = {L}_{k} \times {L}_{k - 1} \times … \times {L}_{1} ( x , t ) ,$$

where, Lᵢ(x)=σ(Wᵢx+bᵢ), Wᵢ represents a weight of a layer i, bᵢ represents a bias term of the layer i, and σ represents an activation function.

In an embodiment, since the total loss function of the PINNs is constructed through embedding physical equations. Theses physical equations are usually expressed as strong or weak forms of physical laws. That is, the wave equation constructed based on the physical law followed by the radiated noise signals during the propagation of the radiated noise signals is expressed in a strong form or a weak form of the physical law followed by the radiated noise signals during the propagation of the radiated noise signals.

When the wave equation is expressed in the strong form of the physical law, the first loss function includes a residual of the wave equation. For example, for a system controlled by a control equation F(u(x,t), ∇u, ∇²u, . . . )=0, a loss function of the system includes a residual of the control equation:

$$Residual = F ( {u}_{NN} ( x , t ) , ∇ {u}_{NN} , {∇}^{2} {u}_{NN} , … ) .$$

When the wave equation is expressed in the weak form of the physical law, the first loss function is derived from an energy functional of the wave equation. For example, when an energy functional is J(u), a goal becomes:

$${min}_{θ} J ( {u}_{NN} ( x , t ; θ ) ) .$$

In specifical implementation, the data loss, namely the first loss function is used to measure the difference between the outputs of the PINNs and labels of the actual types of the ships. Cross-entropy is especially suitable for classification tasks, and its goal is to minimize differences between prediction probabilities and actual labels. A formula of the cross-entropy is expressed as follows:

$${L}_{data} = - \frac{1}{M} {\sum }_{i = 1}^{M} {\sum }_{c = 1}^{C} {l}_{i , c} log ( {\hat{l}}_{i , c} ) ,$$

where, l_{i,c} represents an actual label of a category c to which a sample i belongs, \hat{l}_{i,c} represents a prediction probability of the category c to which the sample i belongs, C represents a number of categories, and M represents a total number of samples.

The physical loss, namely the second loss function, is a special term introduced by the PINNs to ensure that the model conforms to relevant physical laws. By embedding the physical law of the wave equation followed by the radiated noise signals during the propagation of the radiated noise signals as a physical constraint into the total loss function of the model, known physical knowledge can be utilized to enhance the generalization ability of the model, even in absence of a large amount of labeled data.

To ensure features of the outputs of the PINNs meet requirements of the wave equation, it is necessary to impose a constraint on the outputs of the PINNs in the training process. The outputs of the PINNs should meet the following constraint, that is, taking whether the predicted types of the ships output by the PINNs satisfy the wave equation as the constraint for the outputs of the PINNs is expressed as follows:

$$\frac{{\partial }^{2} u}{\partial {t}^{2}} - {c}^{2} {∇}^{2} \hat{u} \approx 0 ;$$

and a calculation formula for the physical loss (the second loss function) is expressed as follows:

$${L}_{physics} = \frac{1}{M} {\sum }_{j = 1}^{M} {( \frac{{\partial }^{2} \hat{u} ( {x}_{j} , {t}_{j} )}{\partial {t}^{2}} - {c}^{2} {∇}^{2} \hat{u} ( {x}_{j} , {t}_{j} ) )}^{2} ,$$

where, L_{physics} represents the second loss function, (xⱼ,tⱼ) represents spatial and temporal coordinates of an j-th sampling point, û(xⱼ,tⱼ) represents an approximate solution of a sound pressure field predicted by the PINNs with parameters θ,

$$\frac{{\partial }^{2} \hat{u} ( {x}_{j} , {t}_{j} )}{\partial {t}^{2}}$$

represents a second derivative of the outputs of the PINNs with respect to time, ∇²û(xⱼ,tⱼ) represents a second derivative of the outputs of the PINNs with respect to space, and M represents a number of the samples.

By summing up and minimizing a physical residual, the PINNs are forced to adjust the outputs thereof, so that the PINNs are not only suitable for data, but also meets the constraints of the wave equation.

Therefore, a final total loss function of the PINNs is a weighted sum of the data loss 1 and the physical loss, expressed as follows:

$${L}_{total} = {λ}_{1} {L}_{data} + {λ}_{2} {L}_{physics} ,$$

where λ₁ and λ₂ represent preset weights.

Step 104, the PINNs are trained by using the radiated noise signals to thereby obtain trained PINNs. The network parameters of the PINNs are optimized based on the first loss function and the second loss function during the training process.

Specifically, during the training process, the network parameters of the PINNs are optimized with a goal of minimizing the first loss function and the second function based on weights of the first loss function and the second function. The weights of the first loss function and the second loss function are dynamically adjusted during the training process.

In specific implementation, to balance influence of different loss components (i.e., the first loss function and the second loss function), the PINNs can dynamically adjust the weights of the first loss function and the second loss function during the training process. One method is to increase a weight of boundary conditions to ensure that the model firstly satisfies the boundary conditions, and then adjust weights of other parts accordingly. Optimization algorithms are used to find optimal neural network parameters with the goal of minimizing the first loss function and the second loss function.

During the training process, the first loss function and the second loss function and their gradients are calculated to update the network parameters. For an adaptive moment estimation (Adam) optimization algorithm, each parameter is updated as follows:

$${θ}_{t + 1} = {θ}_{t} - η \frac{{m}_{t}}{\sqrt{{v}_{t}} + ϵ} ,$$

where θₜ represents the network parameter of the PINNs, θₜ₊₁ represents an optimized network parameter of the PINNs, mₜ represents an exponentially weighted moving average of a gradient, vₜ represents an exponentially weighted moving average of a square gradient, n represents a learning rate, and e represents a preset numerical stability.

It should be understood that, because key links of passive underwater target identification mainly include feature extraction, feature selection, and classification decision. That is, the key links of the passive underwater target identification have made great progress, laying a good foundation for development of this technology. However, when faced with practical applications, these research fields still face many problems, such as small amount of data, low matching degree between identification models and actual physical problems, etc. To reduce influence of the aforementioned problems on identification results, the embodiment is equivalent to proposing a method for identifying the radiated noise of the ships based on the PINNs, which introduces the physical loss based on the wave equation to constrain the training process. A technical flow chart of this method is illustrated in FIG. 2.

This method is divided into two parts, namely feature extraction and classification prediction. The inputs of the PINNs are the normalized radiated noise signals of the ships, namely a series of time series data. The outputs of the PINNs are prediction results of classification labels. For the training process, a strategy of first partitioning and then augmenting is adopted. Firstly, a dataset is divided into a training set, a validation set and a testing set according to a ratio of 8:1:1, and then 10 decibels (dB) to 15 dB Gaussian white noise is added to the training set for data augmentation. This operation can prevent feature information of the training set from leaking to the testing set, and greatly reduce probability of overfitting.

During the training process, domain points and boundary points are input into the PINNs, and the PINNs undergo forward and backward propagation iterations to minimize losses. Moreover, in order to evaluate physical consistency and numerical accuracy of the model, prediction is made on a group of data that are not used in the training process.

Step 105, the radiated noise of the ships is identified through the trained PINNs.

Specifically, a final output of the trained PINNs u_{NN}(x,t) is a solution that approximates real physical behavior. The final output can be compared with known analytical solutions or experimental results to evaluate accuracy.

In the embodiment, by introducing the wave equation constructed based on the physical low followed by the radiated noise signals during the propagation, the total loss function of the model not only include loss of training data (i.e. the first loss function), but also include the physical loss based on the wave equation constructed through the wave equation (i.e. the second loss function). When training the PINNs by using the radiated noise signals generated by the ships during the navigation of the ships, the physical loss is used to constraint the training process, and the actual physical phenomena is taken into account, so that the trained PINNs have better identification performance. Moreover, with addition of the physical loss, the loss of training data is no longer a main factor affecting model training, thereby eliminating a need for large-scale datasets for training and reducing a probability of model overfitting.

The method for identifying the radiated noise of the ships is validated below with reference to a specific experiment.

### (1) Datasets Involved in the Experiment

The dataset is composed of two parts: a ShipsEar dataset and a Northwestern Polytechnical University (NWPU) dataset. To increase diversity of the samples, a new data set named Integral dataset is created by combining the ShipsEar dataset and the NWPU dataset. In addition, due to significant differences between the ShipsEar dataset and the NWPU dataset, this method also helps to demonstrate strong generality and adaptability of the model proposed by the disclosure. Detailed introduction to the ShipsEar dataset and NWPU dataset is as follows.

i. The ShipsEar Dataset

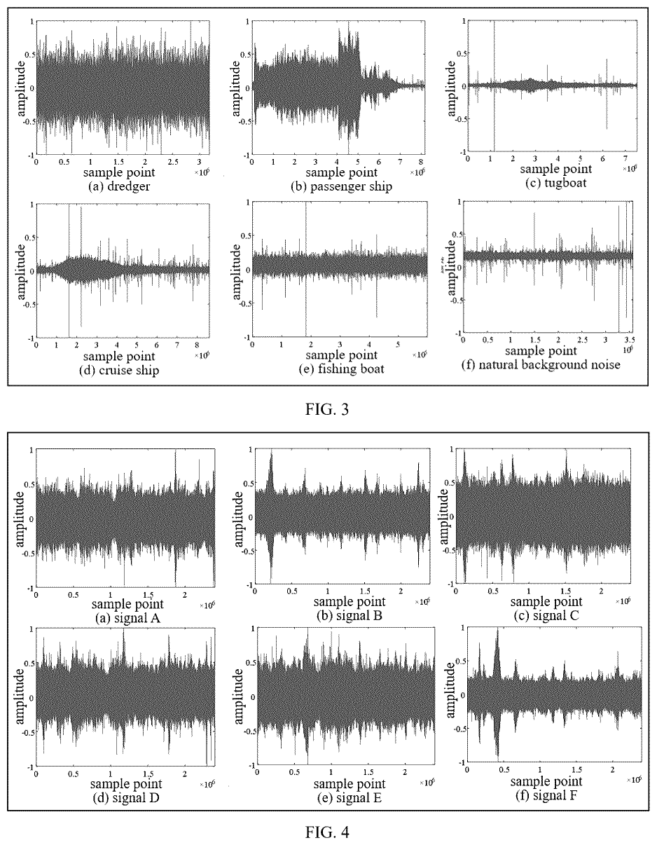

The ShipsEar dataset is developed to address a problem of shortage of available audio data for underwater acoustic research, providing a rich collection of underwater ship noise records. The ShipsEar dataset includes records from 11 different types of ships, such as fishing boats, ferries, ocean liners, and container ships, as well as natural background noise such as wind, rain, and waves. These records are captured by digitalHyd SR-1 autonomous acoustic recorders equipped with hydrophones, with a sensitivity of −193.5 decibels relative to 1 volt per 1 micropascal (dB re 1V/1 μPa) and a frequency response of 1 Hertz (Hz) to 28 kilohertz (kHz). A recording system operates at a sampling rate of 52734 Hz, and each of the records is recorded in detail, including the types of ships, environmental conditions, a position in a global positioning system (GPS), and a depth of the hydrophone. In order to apply the ShipsEar dataset to classification experiments, authors of the ShipsEar dataset divide the dataset into five categories and name them category A, category B, category C, category D, and category E. FIG. 3 illustrates timing diagrams of some signals in the ShipsEar dataset.

ii. The NWPU Dataset

Radiated noise data of the ships in the NWPU dataset comes from ship signal acquisition experiments. In these experiments, the radiated noise data of 61 ships are collected, and all the radiated noise data are sampled at 20 kHz. The NWPU dataset includes three categories of signals, named category F, category G, and category H. FIG. 4 illustrates timing diagrams of some signals in the NWPU dataset.

iii. The Integral Dataset

Due to difference in sampling frequency and signal length between the ShipsEar dataset and the NWPU dataset, the following steps are taken to achieve an experimental goal: 1, merging the two datasets; 2, ensuring that the Integral dataset is suitable for comparative experiments; 3, reducing influence of uneven sample distribution on experimental results. Firstly, 400,000 points are cut from all samples of all categories of signals in the ShipsEar dataset and the NWPU dataset as new samples. Subsequently, each category of signals is divided into the training set, the validation set, and the test set according to the ratio of 8:1:1. Finally, a sample number of each category of signals is increased to 50 through a data augmentation method, that is, Gaussian white noise with signal-to-noise ratio of 10 dB to 15 dB is randomly added to each sample.

### 2. Experiment Configuration

The experiment is conducted on a Windows 11 operating system. A hardware configuration is advanced micro devices (AMD) EPYC™ 7542 central processing unit (CPU) and NVIDIA ray tracing texel extreme (RTX) 4090 graphics processing unit (GPU) (24 gigabyte (GB) video random access memory (VRAM)), and 256 GB of system memory. A software environment includes MATLAB 2022a and Python 3.12, and a deep learning framework PyTorch supports compute unified device architecture (CUDA) 11.7 acceleration. A PINNs architecture is used in the experiment, which consists of a feature extraction module and a classifier module using Sin activation function. A batch size is set to 256, a number of iterations is set to 100, and an initial learning rate is set to 0.001. Initial weights of the data loss and the physical loss are set to 1, and an optimizer is Adam.

i. Identification Experiment Based on Different Datasets

Original datasets prepared are used as input for the model after normalization. An aim of the normalization is to reduce influence of data differences on feature extraction and subsequent classification predictions. At this point, a fluctuation range of minimum maximum normalized data is limited to [0,1].

Theoretically, since the physical loss is added to the PINNs, the wave equation followed by the radiated noise signals during the propagation of the radiated noise signals is taken into account, therefore, the loss of training data is no longer the main factor affecting the model training, thereby eliminating the need for the large-scale datasets for training and reducing the probability of overfitting. These advantages greatly reverse the disadvantages of difficult data acquisition and lack of the large-scale datasets for underwater acoustic signals. In order to connect theory with practice and verify whether identification performance of the model proposed in the disclosure is consistent with inference, numerical experiments are conducted on models with embedded and non-embedded the loss based on physics by using the ShipsEar dataset, the NWPU dataset, and the Integral dataset. The experimental results on different datasets are shown in table 1.

TABLE 1

| | | | | | Area under the |
|---|---|---|---|---|---|
| Method | Dataset | Precision | Recall | F1-Score | curve (AUC) |
| Baseline method | ShipsEar dataset | 0.7850 | 0.7400 | 0.7416 | 0.8120 |
| (only based on | NWPU dataset | 0.8048 | 0.7667 | 0.7611 | 0.8213 |
| data loss) | Integral dataset | 0.7667 | 0.7000 | 0.7067 | 0.7907 |
| method proposed | ShipsEar dataset | 0.8762 | 0.8400 | 0.8399 | 0.9200 |
| by the disclosure | NWPU dataset | 0.8889 | 0.8667 | 0.8560 | 0.9105 |
| | Integral dataset | 0.8915 | 0.8450 | 0.8495 | 0.9193 |

On all datasets, performance of the method proposed by the disclosure is significantly better than the baseline method, and there is a comprehensive improvement in four key indicators of Precision, Recall, F1 Score, and AUC. Especially on the ShipsEar dataset and the Integral dataset, the model with the physical loss has increased by more than 10% in AUC and F1-Score, respectively, indicating that it has strong learning ability for small-scale datasets and can better avoid overfitting. In addition, a value of the AUC of each dataset is higher in the method proposed by the disclosure, because the AUC is a global indicator that measures distinguishing ability of the model in all categories. Even though precision of some categories is low, the AUC can still demonstrate good performance of the model as a whole. Although values of indicator of each dataset in the baseline method are above 0.7, a probability of overfitting is relatively high in an actual training process, and multiple parameter adjustments are needed to avoid overfitting. These results fully verify the effectiveness of introducing the physical constraints into the network, highlight robustness and generalization ability of the method embedded with the physical loss when data acquisition is difficult and a scale of a dataset is small, and further validate the consistency between theoretical derivation and practical application.

ii. Identification Experiment Based on Different Methods

Four identification methods respectively based on deep learning (CNN and RNN), modal decomposition (VMD and CEEMDAN) are compared. For convenience of distinguishment, these four methods are referred to as RM1, RM2, RM3 and RM4 respectively. RM5 refers to a method denoising the original datasets on a basis of the method proposed by the disclosure. RM6 refers to a method that takes MFCC feature of the original datasets as the inputs of the PINNs. RM7 is a combination of RM5 and RM6. Since a dataset of the experiment is not a standard dataset, network structures of other methods have been modified to adapt to the dataset of the experimental, and efforts have been made to ensure that core ideas of these methods are implemented. After conducting multiple experiments and optimizing hyperparameters, experimental results of different methods are shown in table 2.

TABLE 2

| Dataset | Method | Precision | Recall | F1-score | AUC |
|---|---|---|---|---|---|
| Integral dataset | RM1 | 0.7932 | 0.7423 | 0.7515 | 0.8161 |
| | RM2 | 0.7805 | 0.7341 | 0.7442 | 0.8037 |
| | RM3 | 0.7986 | 0.7508 | 0.7583 | 0.8185 |
| | RM4 | 0.7741 | 0.7219 | 0.7284 | 0.7967 |
| | RM5 (adding | 0.8091 | 0.7750 | 0.7775 | 0.8325 |
| | denoising) | | | | |
| | RM6 (adding MFCC) | severe overfitting | | | |
| | RM7 (adding denoising | severe overfitting | | | |
| | and MFCC) | | | | |
| | method proposed by | 0.8715 | 0.8250 | 0.8295 | 0.9193 |
| | the disclosure | | | | |

It can be seen from the table 2, the method proposed by the disclosure is significantly superior to other methods on the Integral dataset, and leads comprehensively in all four indicators, with the value of AUC of 0.9193, far exceeding an optimal value of 0.8325 of comparative methods. After extracting the MFCC features of the dataset, some noise features may overwhelm original features, and a dimension of the dataset is greatly reduced, which is not conducive to training neural network-based methods, resulting in severe overfitting of RM6 and RM7. Compared with RM6 and RM7, the method proposed in the disclosure significantly reduces the risk of overfitting by introducing the physical constraints, while improving the generalization ability, especially in a case of data scarcity, showing stronger robustness and practical application potential. Considering computational and time complexity, the other comparative methods require a significant amount of time and computational resources to preprocess the original datasets, while the method proposed by the disclosure only needs to normalize the original datasets. The above experimental results fully verify the effectiveness of the PINNs and their adaptability to a field of ship radiated noise signals.

Division of steps in the aforementioned method is only for clear description. During implementation, some steps can be merged into one step or split into multiple steps, and as long as they include the same logical relationship, they fall within a scope of protection of the disclosure. Addition of irrelevant modifications or introduction of irrelevant designs to algorithms or flows without altering core designs of the algorithms and the flows fall within the scope of protection of the disclosure.

A system for identifying the radiated noise of the ships is provided by another embodiment of the disclosure. The system for identifying the radiated noise of the ships provided by the embodiment will be described in detail as follows. The following contents are only for convenience of understanding implementation details provided in the disclosure, and are not necessary for implementing this solution. The system for identifying the radiated noise of the ships provided by the embodiment includes a signal acquisition module, an equation construction module, a function construct module, a network training module, and a ship identification module. The signal acquisition module is configured to acquire the radiated noise signals generated by the ships during the navigation of the ships. The equation construction module is configured to construct the wave equation based on the physical law followed by the radiated noise signals during the propagation of the radiated noise signals. The function construct module is configured to construct the first loss function based on the differences between the actual types of the ships indicated by the radiated noise signals and the predicted types of the ships output by the PINNs based on the radiated noise signals and construct the second loss function by taking whether the predicted types of the ships output by the PINNs satisfy the wave equation as the constraint for the outputs of the PINNs. The network training module is configured to train the PINNs by using the radiated noise signals to thereby obtain trained PINNs and optimize the network parameters of the PINNs based on the first loss function and the second loss function during the training process. The ship identification module is configured to identify the radiated noise of the ships through the trained PINNs.

In an embodiment, the signal acquisition module, the equation construction module, the function construct module, the network training module, and the ship identification module are embodied by at least one memory and at least one processor coupled to the at least one memory, and the at least one memory is stored with computer programs executable by the at least one processor.

In an embodiment, the PINNs are implemented as computer-executable instructions stored in a non-transitory computer-readable storage medium and executed by at least one processor coupled to at least one memory, and the at least one memory is stored with computer programs executable by the at least one processor.

It is not difficult to find that this embodiment is a system embodiment corresponding to the aforementioned method embodiment, and this system embodiment can be implemented in cooperation with the aforementioned method embodiment. Related technical details and technical effects mentioned in the aforementioned method embodiment are still valid in this system embodiment, so in order to reduce repetition, they are not repeated here. Accordingly, related technical details mentioned in this system embodiment can also be applied to the aforementioned method embodiment.

It should be noted that, each module involved in this embodiment is a logical module. In practical application, a logical unit can be a physical unit, a part of a physical unit, or a combination of multiple physical units. In addition, in order to highlight innovation of the disclosure, units that are not closely related to solving the technical problem proposed by the disclosure are not introduced in this embodiment, but this does not mean that there are no other units in this embodiment.

A computer device provided by further another embodiment of the disclosure includes at least one processor, and a memory communicatively connected with the at least one processor. The memory is configured to store instructions executable by the at least one processor. The instructions are executed by the at least one processor to make the at least one processor to execute the method for identifying the radiated noise of the ships as described in aforementioned embodiments.

The memory and the at least one processor are connected by a bus, which can include any number of interconnected buses and bridges. The bus can connect various circuits of one or more processors and memory together. The bus can also connect various other circuits such as peripheral devices, voltage regulators, and power management circuits together, which are well known in this field, and therefore will not be further described herein. A bus interface provides an interface between the bus and a transceiver. The transceiver can be one component or multiple components, such as multiple receivers and transmitters, providing a unit for communicating with various other devices on a transmission medium. Data processed by a processor is transmitted on a wireless medium through an antenna, and further, the antenna receives data and transmits the data to the processor.

The processor is responsible for managing the bus and general processing, and can also provide various functions, including timing, peripheral interfaces, voltage regulation, power management, and other control functions. And the memory can be used to store data used by the processor when performing operations.

A non-transitory computer-readable storage medium stored a computer program thereon is provided by still another embodiment of the disclosure. The method for identifying the radiated noise of the ships as described above is executed when the computer program is executed by the processor.

That is, those skilled in the art should understand that, all or part of the steps in the aforementioned method can be completed by instructing related hardware through a program, which is stored in a storage medium and includes several instructions to make a device (which can be a single chip microcomputer, chip, etc.) or the processor execute all or part of the steps of the method of each embodiment of the disclosure. The aforementioned storage medium includes: a universal disk, a mobile hard disk, a read-only memory (ROM), a random access memory (RAM), a magnetic disk, or optical disk and other media that can store program codes.

Those skilled in the art should understand that the aforementioned embodiments are specific embodiments for realizing the disclosure, but in practical application, various changes can be made to the aforementioned embodiments in form and detail without departing from a spirit and the scope of the disclosure.

What is claimed is:

1. A method for identifying radiated noise of ships, comprising the following steps:
acquiring radiated noise signals generated by the ships during navigation of the ships;
constructing, based on a physical law followed by the radiated noise signals during propagation of the radiated noise signals, a wave equation;
constructing, based on differences between actual types of the ships indicated by the radiated noise signals and predicted types of the ships output by physics-informed neural networks (PINNs) based on the radiated noise signals, a first loss function; and constructing, by taking whether the predicted types of the ships output by the PINNs satisfy the wave equation as a constraint for outputs of the PINNs, a second loss function;
training the PINNs by using the radiated noise signals to thereby obtain trained PINNs, and optimizing, based on the first loss function and the second loss function, network parameters of the PINNs during training the PINNs; and
identifying the radiated noise of the ships by using the trained PINNs;
wherein the wave equation is expressed as follows:
$$\frac{{\partial }^{2} u}{\partial {t}^{2}} = {c}^{2} {∇}^{2} u ,$$
where u represents a sound pressure, c represents a sound speed, and ∇²u represents a Laplace operator.

2. The method for identifying the radiated noise of the ships as claimed in claim 1,
wherein the taking whether the predicted types of the ships output by the PINNs satisfy the wave equation as a constraint for outputs of the PINNs is expressed as follows:
$$\frac{{\partial }^{2} u}{\partial {t}^{2}} - {c}^{2} {∇}^{2} \hat{u} \approx 0 ;$$
and the second loss function is expressed as follows:
$${L}_{physics} = \frac{1}{M} {\sum }_{j = 1}^{M} {( \frac{{\partial }^{2} \hat{u} ( {x}_{j} , {t}_{j} )}{\partial {t}^{2}} - {c}^{2} {∇}^{2} \hat{u} ( {x}_{j} , {t}_{j} ) )}^{2} ,$$
where,
$$\frac{{\partial }^{2} \hat{u} ( {x}_{j} , {t}_{j} )}{\partial {t}^{2}}$$
represents a second derivative of the outputs of the PINNs with respect to time, ∇²û(xⱼ,tⱼ) represents a second derivative of the outputs of the PINNs with respect to space, and M represents a number of samples.

3. The method for identifying the radiated noise of the ships as claimed in claim 1, wherein the wave equation is expressed in a strong form or a weak form of the physical law followed by the radiated noise signals during the propagation of the radiated noise signals; and
the first loss function comprises a residual of the wave equation when the wave equation is expressed in the strong form of the physical law; or the first loss function is derived from an energy functional of the wave equation when the wave equation is expressed in the weak form of the physical law.

4. The method for identifying the radiated noise of the ships as claimed in claim 1, wherein the optimizing, based on the first loss function and the second loss function, network parameters of the PINNs during training the PINNs comprises:
optimizing, based on weights of the first loss function and the second function, the network parameters of the PINNs with a goal of minimizing the first loss function and the second function during training the PINNs; wherein the weights of the first loss function and the second loss function are dynamically adjusted during training the PINNs.

5. The method for identifying the radiated noise of the ships as claimed in claim 4, wherein each of the network parameters of the PINNs is optimized through the following formula:
$${θ}_{t + 1} = {θ}_{t} - η \frac{{m}_{t}}{\sqrt{{v}_{t}} + ϵ} ,$$
where θₜ represents the network parameter of the PINNs, θₜ₊₁ represents an optimized network parameter of the PINNs, mₜ represents an exponentially weighted moving average of a gradient, vₜ represents an exponentially weighted moving average of a square gradient, n represents a learning rate, and e represents a preset numerical stability term.

6. The method for identifying the radiated noise of the ships as claimed in claim 1, wherein the first loss function is constructed based on a cross-entropy loss function.

7. A system for identifying radiated noise of ships, comprising:
a signal acquisition module, configured to acquire radiated noise signals generated by the ships during navigation of the ships;
an equation construction module, configured to construct a wave equation based on a physical law followed by the radiated noise signals during propagation of the radiated noise signals;
a function construct module, configured to: construct a first loss function based on differences between actual types of the ships indicated by the radiated noise signals and predicted types of the ships output by PINNs based on the radiated noise signals, and construct a second loss function by taking whether the predicted types of the ships output by the PINNs satisfy the wave equation as a constraint for outputs of the PINNs;
a network training module, configured to: train the PINNs by using the radiated noise signals to thereby obtain trained PINNs, and optimize network parameters of the PINNs based on the first loss function and the second loss function during training the PINNs; and
a ship identification module, configured to identify the radiated noise of the ships through the trained PINNs;
wherein the wave equation is expressed as follows:
$$\frac{{\partial }^{2} u}{\partial {t}^{2}} = {c}^{2} {∇}^{2} u ,$$
where u represents a sound pressure, c represents a sound speed, and ∇²u represents a Laplace operator.

8. A computer device, comprising at least one processor, and a memory communicatively connected with the at least one processor; wherein the memory is configured to store instructions executable by the at least one processor, and the instructions are executed by the at least one processor to make the at least one processor to execute the method for identifying the radiated noise of the ships as claimed in claim 1.

9. A computer-readable storage medium stored a computer program thereon, wherein the method for identifying the radiated noise of the ships as claimed in claim 1 is executed when the computer program is executed by a processor.
